(19) United States
(12) Patent Application Publication
(10) Pub. No.: US 2005/0042908 A1
(43) Pub. Date: Feb. 24, 2005

(54) Socket connector

(76) Inventors: Po-Ning Sun, Tu-chen (TW); Wen-Hsiang Lin, Tu-Chen (TW); Paohua Huang, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/924,696

(22) Filed: Aug. 23, 2004

(30) Foreign Application Priority Data
Aug. 22, 2003 (TW) 92123142

(51) Int. Cl. H01R 13/625; H01R 4/50

(52) U.S. Cl. 439/342

(57) ABSTRACT

A socket connector (1) is provided which comprises a base (12) having a plurality of passages (126) formed therein, the passages are arrayed along a mounting surface (120) of the base, and each passage receives a conductive terminal therein. A cover (11) is attached to the base and adapted to slide on the base in a predetermined sliding direction. A plurality of recesses (130) is formed in the base and arrayed between some of adjacent arrays of the passages of the base, and the whole amount of the recesses in the base is less than the whole amount of the passages of the base.

### BACKGROUND OF THE INVENTION

1. Field of the Invetion

The present invention relates to the art of electrical connectors, and more particularly to a socket connector which electrically connects a central processing unit (CPU) and a printed circuit board (PCB).

2. Related Art

Ball grid array (BGA) type socket connector is commonly used to be mounted on a motherboard of an electronic device to electrically connect an integrated circuit (IC) chip to the motherboard, i.e., to connect an Intel P4 CPU Chip to a PCB of a personal computer. Referring to FIGS. 1 and 2, one kind of conventional BGA socket connector 30 is illustrated. The socket connector 30 typically comprises a base 36 and a cover 32 attached to the base 36 and sliding with respect to the base under driving of a cam 34 which is set between the cover 32 and the base 36. The base 36 further includes a plurality of passages 38 arrayed thereon, each passage 38 receives an electronic terminal (no shown in the FIGS.) therein. The terminals function as conductive path to establish electrical connection between two separate electronic components, each terminal has a solder portion which is fused with a fusible material, i.e., a solder ball. It is important for most situations that a substrate-engaging surface of all the solder balls are coplanar to form a substantially flat mounting interface so that the solder balls can reflow and solder evenly to a planer surface of a PCB. Any significant differences in solder coplanarity can cause poor soldering performance the connector is used to establish electrical connection.

The base is often made of insulative material such as plastic, and since the base has a plurality passages formed therein, residual stresses in such insulative base can result from the molding processing, from the build up of stress as a result of terminal insertion, or a combination of both. During manufacturing process of the connector, a heating step is provided which aims at fusing the solder ball to the solder portion of the terminal. The base may become warped or twisted upon heating to temperatures necessary in the heating step. Such warping or twisting of the base can cause unreliable soldering because the solder balls are not sufficiently in contact with the planar surface of the PCB.

Attempts to solve the above disclosed problem have been developed from several different ways. One way is to add a supplementary step in the manufacturing process of the connector. That is, after the base goes through the heating step, it will be transferred to a pressing device in which the base is pressed to obtain a relatively planar plane thereby decreasing warping or twisting. However, the additional manufacturing step will increasing the overall cost of the connector, which is an unwilling waste to the manufacturer. Another way to decreasing warping or twisting of the base is disclosed in FIGS. 3 and 4, which illustrates the subject matter of a U.S. patent application Ser. No. 10/290,024. Referring to FIG. 4, each passages 38′ has a recess 380′ formed there adjacent, the recess 380′ has a predetermined shape and depth in the base 36′, which can effectively adjust coplanarity of the base 36′. However, it is found that such adjustment is often overmuch to ensure the coplanarity of the base. Therefore, a more effective way is still required for achieving a much better settlement of the warping or twisting problem of the connector.

### SUMMARY OF THE INVENTION

An object of the present invention is to provide a BGA type socket connector which can provide excellent coplanarity of an insulative housing the connector thereby ensuring reliable electronic performance of the connector.

Another object of the present invention is to provide an insulative housing for an electrical connector which has structures to decease warping or twisting of the housing upon heating to temperatures necessary in an heating step.

To fulfill the above objects, an BGA type socket connector of the present invention comprises a base having a plurality of passages formed therein, the passages are arrayed in the base along a mounting surface of the base, each passage receives a conductive terminal therein. A cover is attached to the base and adapted to slide on the base in a predetermined sliding direction with respect to the base. A plurality of recesses is formed in the base and arrayed between some of adjacent arrays of the passages of the base, and the whole amount of the recesses in the base is less than the whole amount of the passages of the base. Each of the recesses has an opening formed in the mounting surface of the base and extends a predetermined depth from the mounting surface toward an opposite surface of the base. The ratio of the amount of the passages and the amount of the recess along the sliding direction is n/N, which is more than 1 and less than 5. The ratio of the amount of the passages and the amount of the recess normal to the sliding direction is also between 1 and 5. Preferably, the ratio n/N is 2, and the recess is a cylinder that comprises a ceiling in the base and a cylindrical opening in the mounting surface.

Other objects, advantages and novel features of the present invention will become more apparent from the following detailed description when taken in conjunction with the accompanying drawings.

### BRIEF DESCRIPTION OF THE DRAWINGS.

FIG. 1 is an isometric view of a conventional electrical connector.

FIG. 2 is an enlarged view of circle II of FIG. 1.

FIG. 3 is an isometric view of another conventional electrical connector.

FIG. 4 is an enlarged view of circle IV of FIG. 3.

FIG. 5 is an exploded view of an electrical connector in accordance with a preferred embodiment of the present invention.

FIG. 6 is an assembled view of the electrical connector of FIG. 5, and seen from another view of angel.

FIG. 7 is an enlarged view of circle VII of FIG. 6.

FIG. 8 is a cross-sectional view take along line VIII-VIII of FIG. 5.

FIG. 9 is an enlarged view take along circle IX-IX of FIG. 5.

FIG. 10 is a graph showing warping range of the electrical connector of the present invention and the conventional electrical connectors along X-direction.

FIG. 11 is a graph showing warping range of the electrical connector of the present invention and the conventional electrical connectors along Y-direction.

### DETAILED DESCRIPTION OF THE PREFERRED EMBODIMENTS

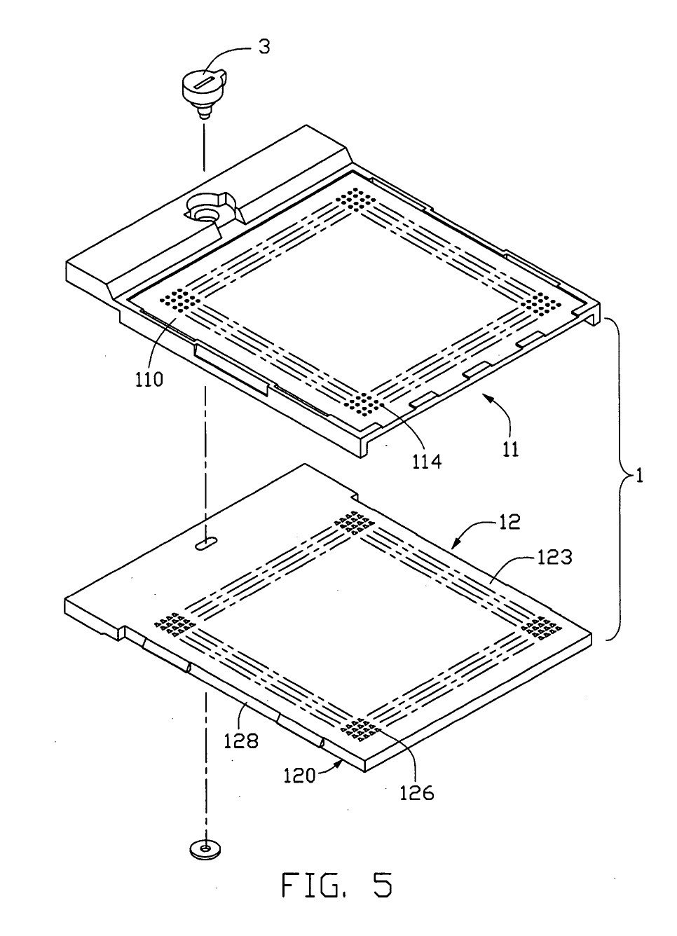

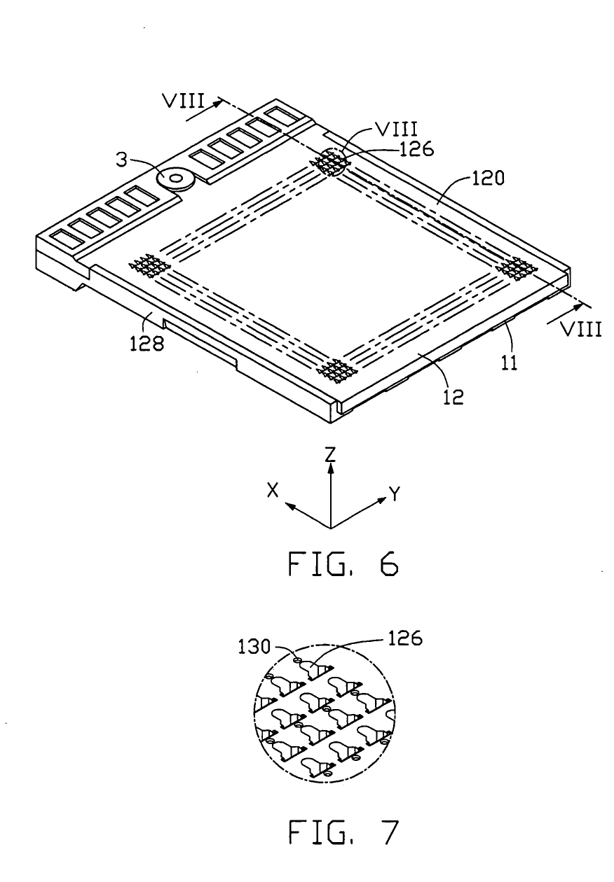

Referring to FIGS. 5 and 6, a BGA type socket connector 1 in accordance with a preferred embodiment of the present invention is illustrated. The connector 1 comprises an insulative base 12, a cover 11 attached to the base 12, and a cam 3 rotatably secured in the base 12 and the cover 11. The cam 3 can drive the cover 11 to slide on the base 12 along a predetermined sliding direction. In this embodiment, the predetermined sliding direction is defined as X-direction; a direction that is normal to the X-direction is defined as Y-direction. The X-direction and Y-direction are respectively labeled as arrows X and Y in FIG. 6. The base 12 is a flat body which comprises a mounting surface 120 adapted to be mounted onto a printed circuit board (PCB, not shown in the FIGS.) and an opposite inner surface 123 adapted to carry the cover 11, a side wall 128 is formed which interconnecting the mounting surface 120 and the inner surface 123 of the base. A plurality of passages 126 is arrayed in the base which extend from the inner surface 123 toward the mounting surface 120; each passage 126 accommodates an electrical terminal (not shown in the FIGS.) therein. Each terminal has a solder portion extending toward the mounting surface 120 of the base 12 and adapted to be soldered with a solder ball. The cover 11 has a mating surface 114 adapted to mate with a central processing unit (CPU, not shown in the FIGS.), which comprises a plurality of holes 114 formed therein and extending throughout the cover 11. Each hole 114 is in alignment with a corresponding passage 126 of the base such that a pin of the CPU can insert into the hole and establish electrical connection with the terminal in the passage.

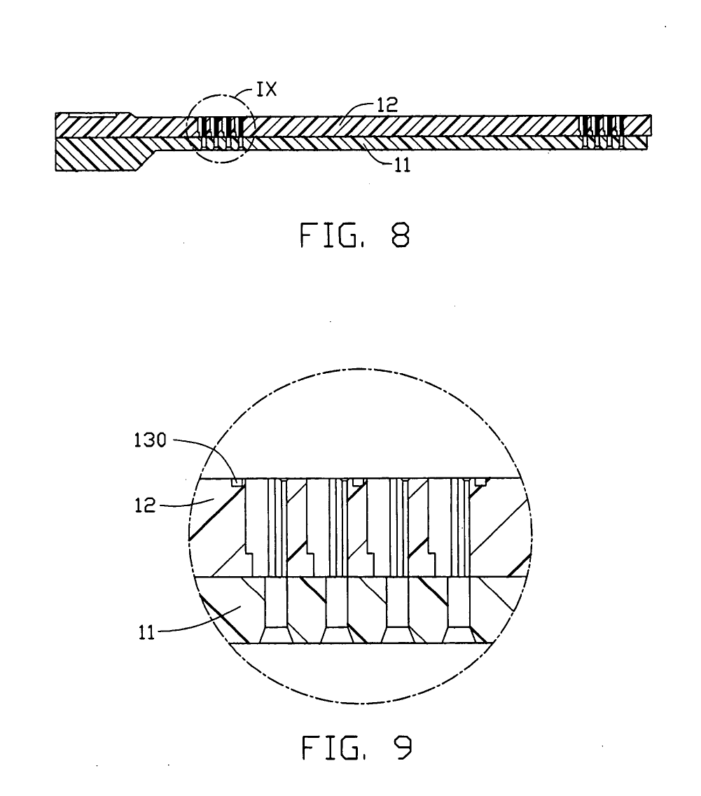

Referring to FIG. 7, a plurality of recesses 130 is formed in the base adjacent the passages 126. In FIG. 7, there are four passage rows 126 in the circle along the X-direction. It can be seen that, along the X-direction, there is no recess 130 formed between the first passage row 126 and the second passage row 126, while there are one row of recess 130 formed between the second passage row 126 and the third passage row 126, and there is no recess 130 formed between the third passage row 126 and the fourth passage row 126, that is, the ratio of the passage rows 126 and the recess rows 130 along the X-direction is 2:1. Similarly, along the Y-direction, each passage row 126 has four passages 126 and two recesses 130, so the ratio of the passage rows 126 and the recess rows 130 along the Y-direction is also 2:1. Therefore, in this embodiment, the amount of the recesses 130 is less than that of the passages 126. Referring to FIGS. 8 and 9, the recess 130 extends a predetermined depth from the mounting surface 120 in the base 12 but does not extend throughout the base 12. In this embodiment, the recess 130 is a cylinder that comprises a ceiling in the base 12 and a cylindrical opening in the mounting surface 120, but the recess 130 can also be molded as other shapes, i.e., a silo or a rhombus, and they all have a ceiling and an opposite opening in the mounting surface of the base. Understandably, the recess 130 can also be modified as a through hole which extends throughout the base.

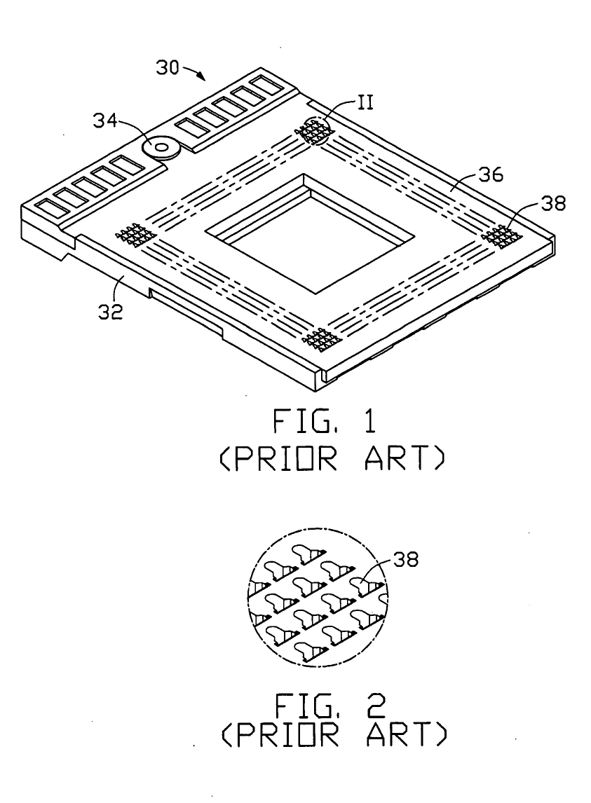

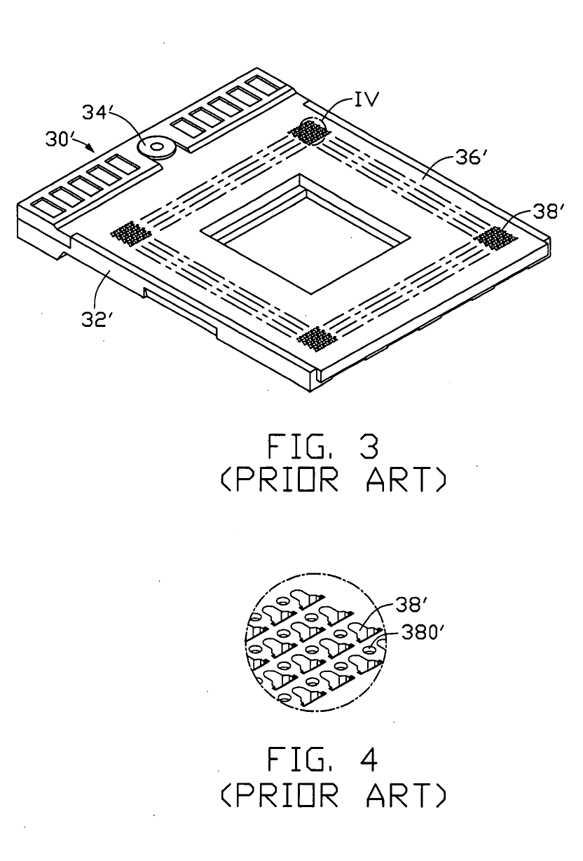

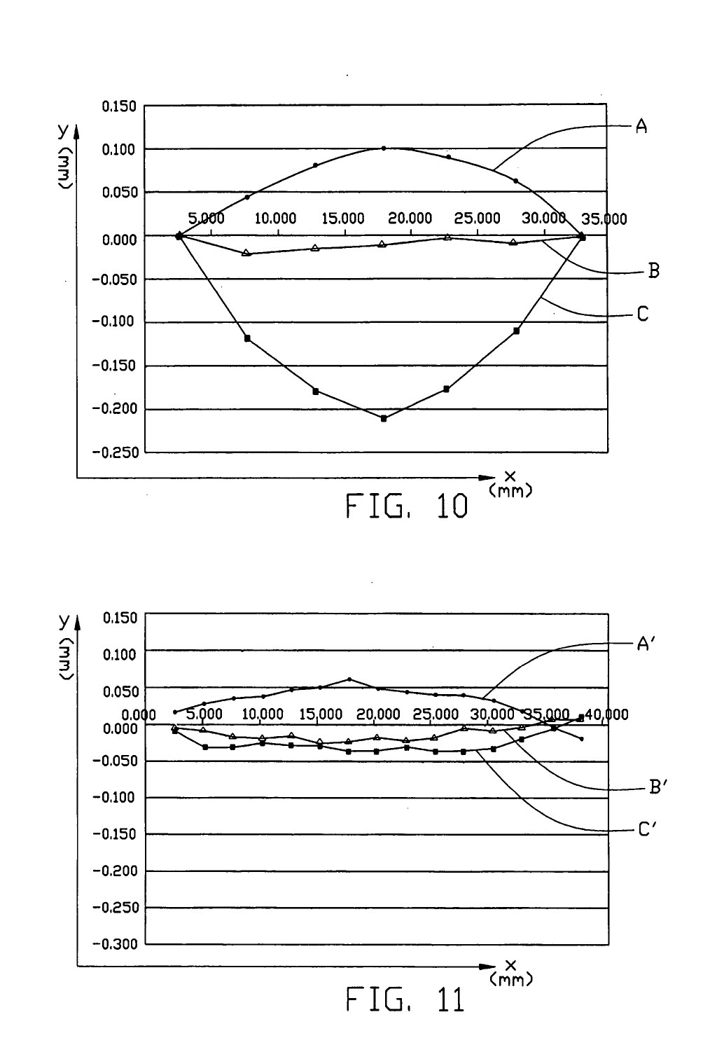

Referring to FIG. 10, a graph is illustrated which shows relationship between warping range of the base 12 and distribution of the recesses 130 in the base along the X-direction. The X-axis is a distance between the base point, the side ball 128, and an uncertain point in the base along the X-direction, the Y-axis is warping range of the uncertain point of the base. The curve A represents the warping status of the prior art base as disclosed in FIGS. 3 and 4, the curve B represents the warping status of the base 12 of the present invention while the ratio of the passage rows 126 and the recess rows 130 along the X-direction is 2:1, and the curve C represents the warping status of the prior art base as disclosed in FIGS. 1 and 2. It can be seen clearly from the graph that the largest warping degree of the curve A is 0.00 mm and the largest warping degree of the curve C is more than 0.200 mm, while the largest warping degree of the curve B is less than 0.025 mm. Therefore, the warping range of the base 12 of the present invention along the X-direction is hugely decreased.

Referring to FIG. 11, a graph is illustrated which shows relationship between warping range of the base 12 and distribution of the recesses 130 in the base along the Y-direction. The curve A′ represents the warping status of the prior art base as disclosed in FIGS. 3 and 4, the curve B′ represents the warping status of the base 12 of the present invention while the ratio of the passage rows 126 and the recess rows 130 along the Y-direction is 2:1, and the curve C′ represents the warping status of the prior art base as disclosed in FIGS. 1 and 2. It can be seen clearly from the graph that the largest warping degree of the curve B′ is obviously smaller than that of the curves A′ and C′. Therefore, the warping range of the base 12 of the present invention along the Y-direction is also effectively decreased.

In this embodiment, the ratios of the passage rows 126 and the recess rows 130 along the X-direction and the Y-direction are defined as 2:1, and the recess 130 is opened from the mounting surface 120 of the base. However, it should be understand that the ratio and positions of the recess can also be modified. As a result of testing, When the ratio, which is defined as n/N, is between 2:1 and 5:1, the warping range of the base can be well decreased. Furthermore, the recess 130 can also be opened from the inner surface 123 of the base 12 and extends a predetermined depth from the inner surface 123 toward the mounting surface 120. Therefore, it is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector, comprising:
a base having a plurality of passages formed therein, the passages being arrayed along a mounting surface of the base, each passage receiving a conductive terminal therein;
a cover attached to the base and adapted to slide on the base in a predetermined sliding direction;
a plurality of recesses being formed in the base and being arrayed between some of adjacent arrays of the passages of the base.

2. The electrical connector of claim 1, wherein the whole amount of the recesses in the base being less than the whole amount of the passages of the base.

3. The electrical connector of claim 2, wherein each of the recesses has an opening formed in the mounting surface of the base and extends a predetermined depth from the mounting surface toward an opposite surface of the base.

4. The electrical connector of claim 2, wherein each of the recesses has an opening formed in a surface opposite to the mounting surface of the base and extends a predetermined depth from the surface toward the mounting surface.

5. The electrical connector of claim 2, wherein the ratio of the amount of the passages and the amount of the recess along the sliding direction is n/N, which is more than 1 and less than 5.

6. The electrical connector of claim 5, wherein n/N is 2.

7. The electrical connector of claim 2, wherein the ratio of the amount of the passages and the amount of the recess normal to the sliding direction is n/N, which is more than 1 and less than 5.

8. The electrical connector of claim 7, wherein n/N is 2.

9. The electrical connector of claim 3, wherein the recess is a cylinder which comprises a ceiling in the base and an cylindrical opening in the mounting surface.

10. The electrical connector of claim 3, wherein the recess is a silo which comprises a top wall in the base and an squared opening toward the mounting surface.

11. The electrical connector of claim 3, wherein the recess is rhombus which comprises a top wall in the base and a triangular opening toward the mounting surface.

12. The electrical connector of claim 1, wherein each base comprises at least four passage arrays along the sliding direction of the cover, there being recess arrays formed between the first passage array and the second array and between the third passage array and the fourth passage array, and there is no recess array formed between the second and the third passage arrays.

13. An insulative housing of an electrical connector, comprising:
a flat body having a mounting surface;
a plurality of passages extending throughout the body from the mounting surface adapted to receiving a corresponding number of terminals therein;
a plurality of recesses being formed in the mounting surface of the body among some of the two adjacent passages and extending from the mounting surface toward an opposite surface of the body.

14. The housing of claim 13, wherein the passages and the recesses are arrayed in the body, the recess array being formed between some of the two adjacent passage arrays and there is not any recess row formed between some of the two adjacent passage arrays.

15. The housing of claim 14, wherein the range of the ratio of the passage arrays and the recess arrays along a longitudinal direction of the body is between 2 and 5.

16. The housing of claim 13, wherein the recess does not extend throughout the body, each recess comprises a ceiling in the body and an opening toward the mounting surface of the body.

17. The housing of claim 13, wherein the shape of the recess is cylindrical.

18. The housing of claim 13, wherein the body comprises at least four passage arrays along a predetermined direction, there being recess arrays formed between the first passage array and the second array and between the third passage array and the fourth passage array, and there is no recess array formed between the second and the third passage arrays.

19. An electrical connector, comprising:
a base having therein a plurality of passages arranged in matrix, the passages being arrayed along a mounting surface of the base, each passage receiving a conductive terminal therein;
a cover attached to the base and adapted to slide on the base in a lengthwise direction perpendicular to lateral direction wherein said lengthwise direction cooperates with said lateral direction to form a plane defined by said mounting surface;
a plurality of recesses being formed in the base among the passages;
said recesses being smaller than the passages and not of a through hole type, an amount of the recesses being less than that of the passages.

20. The electrical connector as claimed in claim 19, wherein each of said passages is dimensioned larger in the lengthwise direction than in the lateral direction, and the recesses are essentially located among and in alignment with the passages in the lengthwise direction rather than in the lateral direction.

21. The electrical connector as claimed in claim 19, wherein a ratio of the amount of the passages with regard to that of the recesses is between 1 and 5.
